(19) United States
(12) Patent Application Publication
(10) Pub. No.: US 2006/0077017 A1
(43) Pub. Date: Apr. 13, 2006

(54) Gyromagnetic component for non-reciprocal circuit device and non-reciprocal circuit device

(75) Inventors: Tsuyoshi Kinoshita, Tokyo (JP); Shunsuke Ideta, Tokyo (JP); Motoi Shimizu, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/245,068

(22) Filed: Oct. 7, 2005

(30) Foreign Application Priority Data
Oct. 8, 2004 (JP) 2004-297003

(51) Int. Cl. H01P 1/32

(52) U.S. Cl. 333/1.1; 333/24.2

(57) ABSTRACT

There are provided a gyromagnetic component and a non-reciprocal circuit device having excellent high-frequency characteristics.

A ferrite substrate 12 and a center electrode 11 are included. At least a part of the ferrite substrate 12 is covered with an insulating film 114. A second central conductor 112 constituting the center electrode 11 is caused to adhere to a surface of an insulating film 12. A non-reciprocal circuit device is configured to incorporate this gyromagnetic component therein.

### BACKGROUND OF THE INVENTION

1. Field of the Invention

The present invention relates to a gyromagnetic component constituting a non-reciprocal circuit device such as an isolator or a circulator, and a non-reciprocal circuit device.

2. Description of the Related Art

A non-reciprocal circuit device such as an isolator or a circulator is used in, e.g., a mobile wireless device such as a portable phone. This type of non-reciprocal circuit device is configured to accommodate a gyromagnetic component constituted of a ferrite substrate, a center electrode and others, a permanent magnet, a matching capacitor(s) and a terminating resistance in a magnetic metal case functioning as a yoke as typified by, e.g., Patent References 1 and 2.

A center electrode is combined with a ferrite substrate, and a direct-current magnetic field is applied thereto from a permanent magnet. The center electrode includes a plurality of central conductors, and has one end arranged on one surface of the ferrite substrate and is earthed as a ground portion to a metal case. The central conductors are insulated from each other and arranged so that they cross each other at a predetermined angle on the other surface of the ferrite substrate, and an end of each central conductor functions as an external terminal.

As a structure in which the center electrode is combined with the ferrite substrate, there are known one type in which a thin metal plate is used as a center electrode material and the thin metal plate is bent and attached to the ferrite substrate and another type in which the center electrode is formed on the ferrite substrate by printing.

Of these two types of center electrode structures, it is generally considered that the latter type is superior to the former in a reduction in size, an increase in frequency and mass productivity.

However, it was revealed that the type in which a center electrode film is formed on a soft magnetic body by printing cannot demonstrate sufficient characteristics as a frequency is increased. One of factors of this phenomenon is considered as follows. That is, since the ferrite substrate is formed of ferrite, irregularities due to ferrite grain boundaries appear on a surface where the electrode is formed, and an end edge of the electrode in a width direction becomes an irregular edge in accordance with the irregularities. When a high-frequency current flows through the electrode which is such a state, a skin effect becomes prominent as the high-frequency current is increased in frequency, and hence high-frequency characteristics are deteriorated.

Patent Reference 1: Japanese Patent Application Laid-open No. 1999-205011

Patent Reference 2: Japanese Patent Application Laid-open No. 1999-97910

### SUMMARY OF THE INVENTION

It is an object of the present invention to provide a gyromagnetic component and a non-reciprocal circuit device having excellent high-frequency characteristics.

To achieve of the object, in a gyromagnetic component for a non-reciprocal circuit device according to the present invention, at least a part of a ferrite substrate is covered with an insulating film, and a center electrode is caused to adhere to a surface of the insulating film.

According to this configuration, an electrode forming surface on which irregularities due to ferrite grain boundaries appear is flattened by the insulating film. Since the center electrode is formed on a surface of the thus flattened insulating film, an end edge of the electrode in a width direction becomes a linear end edge with less irregularity. Therefore, even if a high-frequency current flows through the center electrode, the skin effect is reduced, thereby maintaining excellent high-frequency characteristics.

The insulating film is preferably formed of a synthetic resin film or a glass film. The insulating film may be provided on the entire electrode forming surface, or may be patterned and provided in a restricted region directly below the center electrode. The center electrode is preferably formed of an electroconductive material mainly containing silver.

The gyromagnetic component according to the present invention is combined with a permanent magnet and a yoke to constitute a non-reciprocal circuit device. The permanent magnet is provided on at least one surface side of the gyromagnetic component, and applies a direct-current magnetic field to the gyromagnetic component. The yoke constitutes a magnetic path for a magnetic field generated by the permanent magnet.

This non-reciprocal circuit device includes the gyromagnetic component according to the present invention, and hence it is superior in high-frequency characteristics.

As described above, according to the present invention, it is possible to provide the gyromagnetic component and the non-reciprocal circuit device having excellent high-frequency characteristics.

The present invention will be more fully understood from the detailed description given here in below and the accompanying drawings which are given by way of illustration only, and thus are not to be considered as limiting the present invention.

### BRIEF DESCRIPTION OF THE DRAWINGS

FIG. 1 is a perspective view showing an external appearance of a gyromagnetic component according to the present invention;

FIG. 2 is a cross-sectional view showing the gyromagnetic component taken along a line 2-2 in FIG. 1;

FIG. 3 is a view showing a problem in the prior art;

FIG. 4 is a view showing a problem in the prior art;

FIG. 5 is a view schematically illustrating a function and an effect of the gyromagnetic component according to the present invention;

FIG. 6 is a view schematically illustrating a function and an effect of the gyromagnetic component according to the present invention;

FIG. 7 is a plan view showing another embodiment of the gyromagnetic component according to the present invention;

FIG. 8 is an exploded perspective view of a non-reciprocal circuit device in which the gyromagnetic component according to the present invention is incorporated;

FIG. 9 is a perspective view showing an assembling state of the non-reciprocal circuit device depicted in FIG. 8;

FIG. 10 is an exploded perspective view showing another embodiment of the non-reciprocal circuit device in which the gyromagnetic component according to the present invention is incorporated;

FIG. 11 is a perspective view showing an assembling state of the non-reciprocal circuit device depicted in FIG. 10;

FIG. 12 is a perspective view showing a component arrangement;

FIG. 13 is an exploded perspective view showing still another embodiment of the non-reciprocal circuit device in which the gyromagnetic component according to the present invention is incorporated;

FIG. 14 shows a manufacturing method of the non-reciprocal circuit device according to the present invention; and

FIG. 15 is a view showing a step following a step depicted in FIG. 14.

### DETAILED DESCRIPTION OF THE PREFERRED EMBODIMENTS

1. Gyromagnetic Component

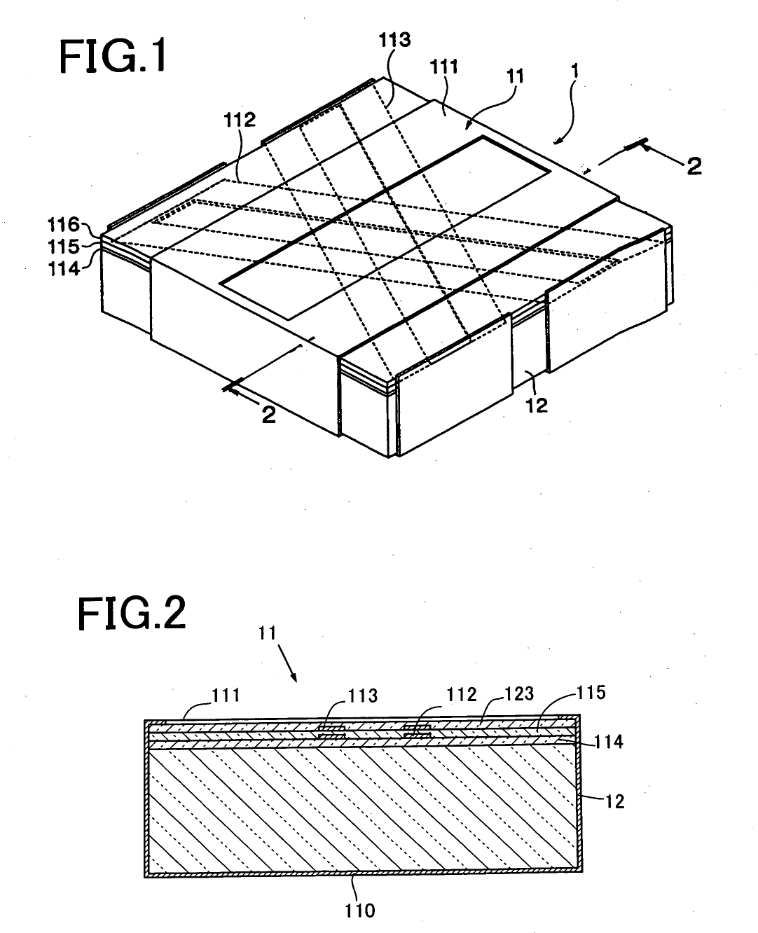

Referring to FIGS. 1 and 2, Since FIG. 2 mainly focuses on showing a configuration of a center electrode part and this part is exaggerated, a three-dimensional size ratio of FIG. 2 does not match with that of FIG. 1.

An illustrated gyromagnetic component 1 includes a center electrode 11 and a ferrite substrate 12. The center electrode 11 includes first to third central conductors 111 to 113. The first to third central conductors 111 to 113 are insulated from each other through insulating films 115 and 116 in such a manner that they cross each other at a predetermined angle on a main surface of the ferrite substrate 12. The first to third central conductors 111 to 113 can be formed by printing as well as means of sputtering, vapor deposition or the like.

Side surface electrodes branching from a substantially square ground portion 110 provided on a lower surface of the ferrite substrate 12 are provided on side surfaces of the ferrite substrate 12, and the first to third central conductors 111 to 113 are connected with these side surface electrodes. It is to be noted that the center electrode 11 means a part which exists on the main surface of the ferrite substrate 12. This is also true to the first to third central conductors 111 to 113. Therefore, the side surface electrodes, the ground electrode and others are not included in the center electrode 11 and the first to third central conductors 111 to 113.

Of the first to third central conductors 111 to 113, the second central conductor 112 positioned on the lowermost side is formed on an insulating film 114 caused to adhere to an upper surface of the ferrite substrate 12.

For the ferrite substrate 12, a soft magnetic material (ferrite) such as yttrium/iron/garnet (YIG) is preferable. Although the ferrite substrate is not restricted to a specific shape, a square shape is preferable.

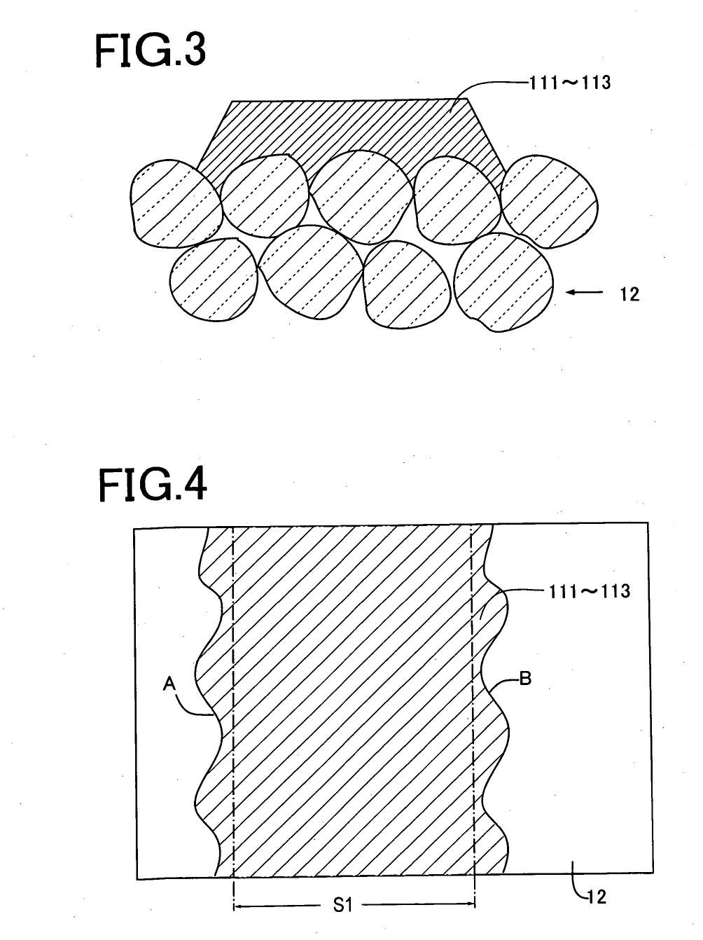

The ferrite substrate 12 is a sintered body, and irregularities appear on the surface due to ferrite grain boundaries as shown in FIG. 3. Therefore, if the first to third central conductors 111 to 113 are caused to directly adhere to the surface of the ferrite substrate 12, end edges A and B of the ferrite substrate 12 in a width direction become irregular edges in accordance with the irregularities as shown in FIG. 4. Such a phenomenon occurs in not only a case where the first to third central conductors 111 to 113 are formed by a printing method but also a case where they are formed by sputtering, vapor deposition or the like. Since the irregularities on the surface of the ferrite substrate 12 are produced due to the ferrite grain boundaries, they cannot be completely removed even if the surface of the ferrite substrate 12 is polished.

In a prior art, since the first to third central conductors 111 to 113 are caused to directly adhere to the surface of the ferrite substrate 12 as shown in FIG. 3, the end edges A and B in the width direction become undulant irregular edges with respect to an originally expected electrode area S1 as shown in FIG. 4. Therefore, a skin effect becomes prominent at the irregular edges A and B as a frequency is increased, and hence there is a problem that high-frequency characteristics are deteriorated.

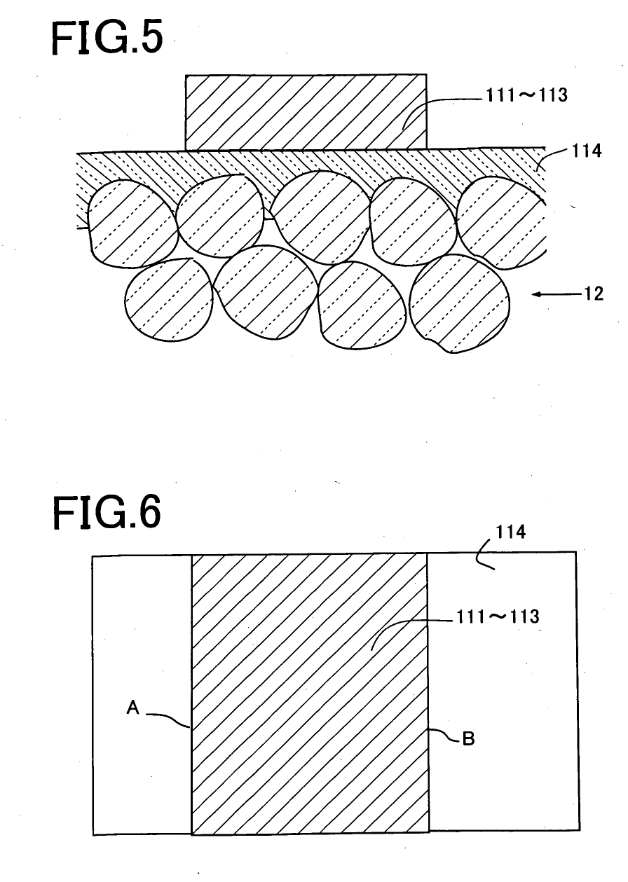

In the present invention, the insulating film 114 is caused to adhere to the upper surface of the ferrite substrate 12, and the second central conductor 112 is formed thereon. When such a configuration is adopted, as schematically shown in FIG. 5, an electrode forming surface on which the irregularities are produced due to the ferrite grain boundaries is flattened by the insulating film 114. Since the second central conductor 112 is formed on the thus flattened surface of the insulating film 114, the end edges A and B of the second central conductor 112 in the width direction become linear end edges without irregularities as shown in FIG. 6. Therefore, even if a high-frequency current flows through the second central conductor 112, the skin effect is reduced, thereby maintaining the excellent high-frequency characteristics.

In the embodiment depicted in FIGS. 1 and 2, an insulating film 115 which covers the second central conductor 112 and the insulating film 114 is provided, the third central conductor 113 is provided thereon, an insulating film 116 which covers the third central conductor 113 and the insulating film 115 is provided, and the first central conductor 111 is provided on this insulating film 116. Insulating films 115 and 116 may be organic insulating films formed of inorganic insulating films. By doing so, the above-described flattening function by the insulating film can be obtained.

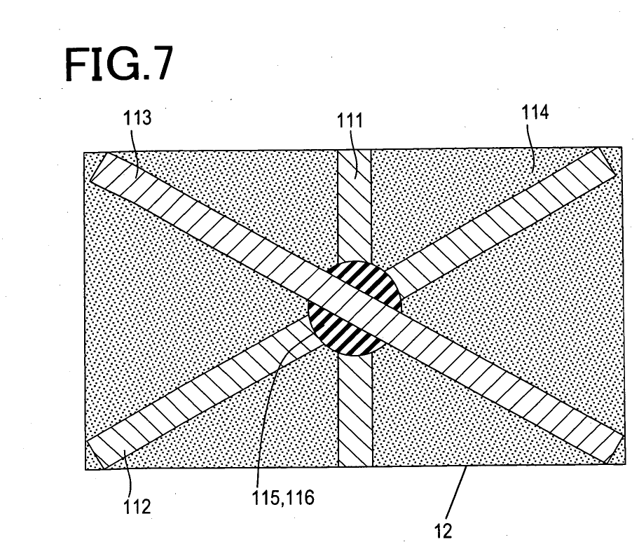

FIG. 7 is a plan view showing another embodiment of the gyromagnetic component according to the present invention. In the illustrated embodiment, insulating films 115 and 116 are provided only at an intersection of the central conductors 111 to 113. Although the first central conductor 111 is caused to adhere to a surface of an insulating film 114 over the entire length thereof, parts of the second central conductor 112 and the third central conductor 113 beyond the intersection are extended on the surface of the insulating film 114. In this case, a flattening function of the insulating film 114 can be obtained on not only the first central conductor 111 but also major parts of the second central conductor 112 and the third central conductor 113 over the entire length.

2. Non-Reciprocal Circuit Device

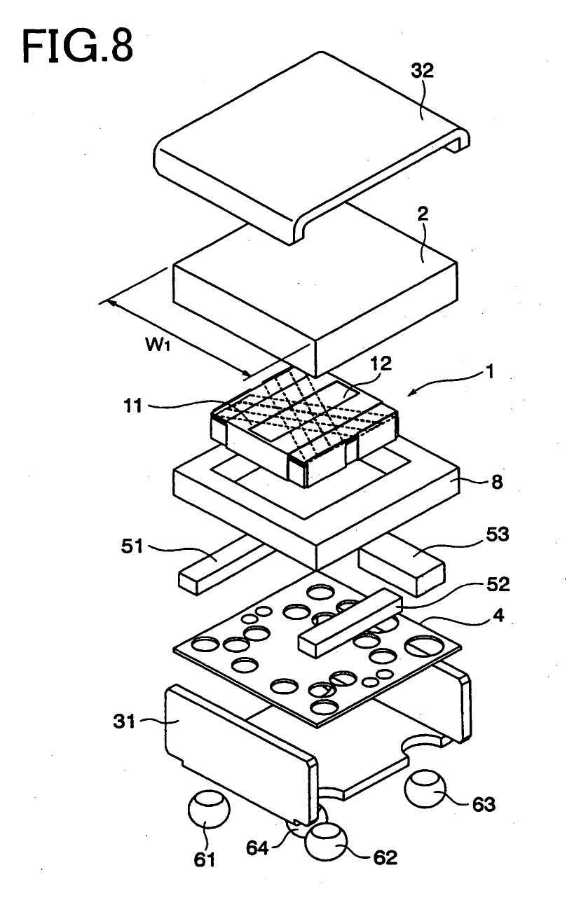

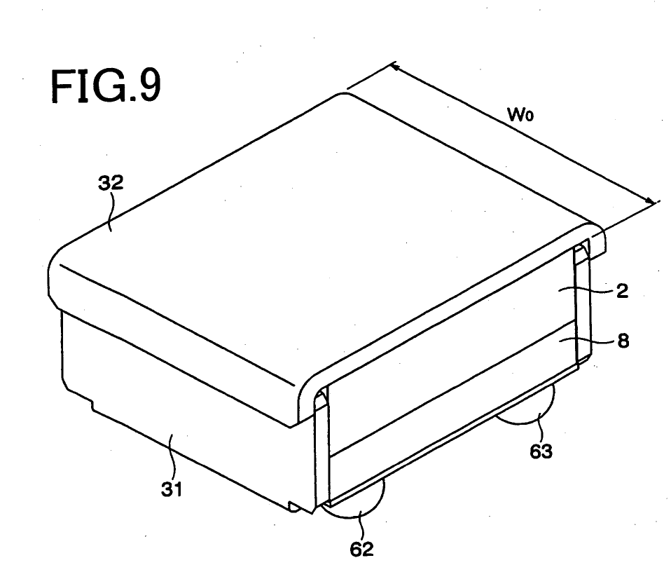

FIGS. 8 and 9 show an example of an isolator.

The non-reciprocal circuit device illustrated in FIGS. 8 and 9 comprises a gyromagnetic component 1, a permanent magnet 2, a first yoke 31 and a second yoke 32 as its essential constituent parts. In the embodiment, it further has a support substrate 4, capacitors 51 and 52, a terminating resistor 53 and a plurality of metal balls 61 to 64 which serve as input/output terminals and ground terminals.

The gyromagnetic component 1 is the gyromagnetic component according to the present invention depicted in FIGS. 1 and 2. The permanent magnet 2 applies a direct-current magnetic field to the gyromagnetic component 1, and is provided on one surface side of the gyromagnetic component 1 in the embodiment. However, the permanent magnet may be provided on both surfaces of the gyromagnetic component 1.

The first yoke 31 and the second yoke 32 constitute a magnetic path for a magnetic field generated by the permanent magnet 2. As a matter of course, each of the first yoke 31 and the second yoke 32 is formed of a magnetic material. Each of the first yoke 31 and the second yoke 32 in the embodiment is obtained by bending a magnetic metal sheet.

In the embodiment, an entire widthwise dimension between both opposing side surfaces of the non-reciprocal circuit device is determined based on a widthwise dimension W1 of the permanent magnet 2. That is, both opposing side surfaces of the permanent magnet 2 are exposed on both the opposing side surfaces of the entire non-reciprocal circuit device to determine a widthwise dimension W0 of the entire non-reciprocal circuit device. A case, which has been conventionally considered as an essential component, is not provided. According to this configuration, a reduction in size can be realized without being restricted by the case.

Further, the entire widthwise dimension W0 between both the opposing side surfaces is determined based on the widthwise dimension W1 of the permanent magnet 2, i.e., both the opposing side surfaces of the permanent magnet 2 are exposed on both the opposing side surfaces of the non-reciprocal circuit device. Therefore, it is possible to adopt, e.g., a process of manufacturing an aggregate in which many non-reciprocal circuit devices are arranged in a lattice-like form to improve efficiency of a manufacturing process of the non-reciprocal circuit device and further applying cutting processing to this aggregate to take out each non-reciprocal circuit device. Accordingly, mass productivity can be greatly improved, thereby providing a small and inexpensive non-reciprocal circuit device.

The first yoke 31 is led through side surfaces different from both the side surfaces on which the side surfaces of the permanent magnet 2 are exposed, i.e., side surfaces in a length direction. In the length direction, an increase in dimension due to a thickness of the yoke must be taken into consideration. However, the first yoke 31 can be formed of a tabular member, and hence an increase in thickness due to the first yoke 31 does not become a serious problem. Although the first yoke 31 has a shape in which both sides of a bottom plate thereof are raised, it is not necessarily restricted to such a shape.

The second yoke 32 is superimposed on the permanent magnet 2. Additionally, both ends of the second yoke 32 are coupled with the first yoke 31, thereby constituting a magnetic path for a magnetic field generated by the permanent magnet 2. Fixed coupling between the first yoke 31 and the second yoke 32 can be realized by mechanical coupling as well as joining using a solder.

The illustrated non-reciprocal circuit device further includes a support substrate 4, the gyromagnetic component 1 and the permanent magnet 2 are mounted on one surface of the support substrate 4, and the entire structure is constrained by using the first yoke 31 and the second yoke 32. According to this configuration, in the structure having no case, the permanent magnet 2, the gyromagnetic component 1 and the support substrate 4 can be assuredly constrained in a predetermined positional relationship, thereby obtaining required characteristics.

An outer shape of the gyromagnetic component 1 described in the embodiment is smaller than that of the permanent magnet 2. According to this configuration, in a case where the above-described manufacturing process and cutting process are adopted, it is possible to avoid giving damage to the gyromagnetic component 1 when executing the processes, especially the cutting process.

When the outer shape of the gyromagnetic component 1 is smaller than that of the permanent magnet 2, there occurs a space due to a difference in outer shape between the gyromagnetic component 1 and the permanent magnet 2. It is preferable to fill this space with an insulating resin 8. By doing so, reliability is improved.

Further, in the embodiment, an outer shape of the support substrate 4 is matched with that of the permanent magnet 2. The outer shape of the support substrate 4 is substantially the same as that of the permanent magnet 2 and, when the gyromagnetic component 1 is arranged above the support substrate 4, a space corresponding to a difference in outer shape is generated between an outer periphery of the gyromagnetic component 1 and an outer periphery of the support substrate 4. The capacitors 51 and 52 and the terminating resistor 53 are arranged in the above-described space, secured to a conductor pattern formed on the support substrate 4 by soldering or the like, and further secured to a predetermined one of the central conductors 111 to 113 by means of soldering or the like so that a known circuit configuration can be obtained. Furthermore, the periphery is filled with the insulating resin 8. As shown in FIG. 8, all of the space does not have to be filled, and exposed surfaces alone may be filled with the insulating resin 8.

Moreover, an appropriate electrode is formed on the support substrate 4, and the metal balls 61 to 64 which serve as input/output terminals and ground terminals are attached by utilizing the electrode and the conductor pattern. The central conductors 111 to 113, the capacitors 51 and 52 and the terminating resistor 53 are connected with the metal balls 61 to 64 so that a predetermined electric circuit can be obtained.

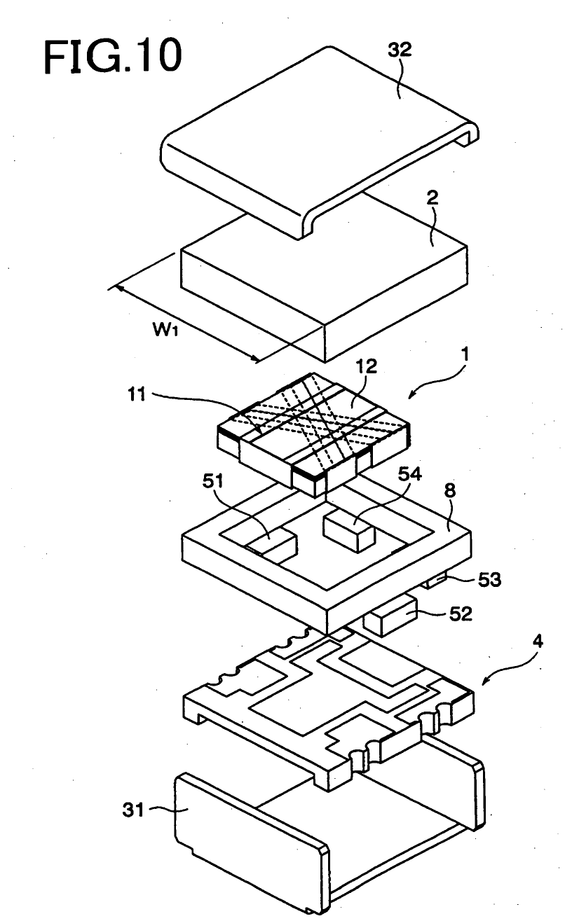

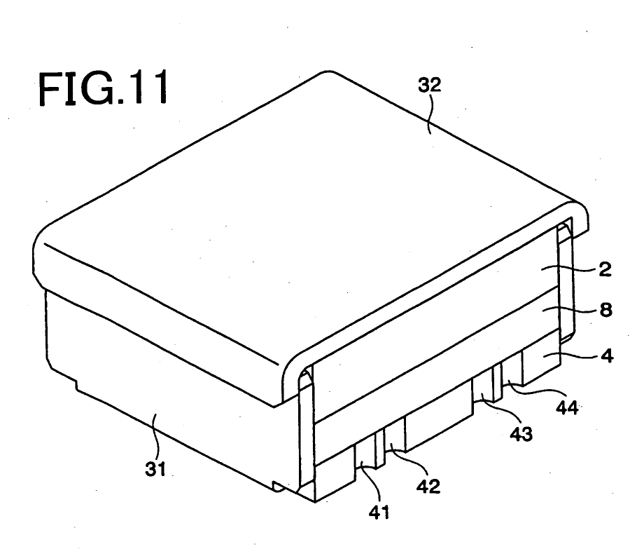

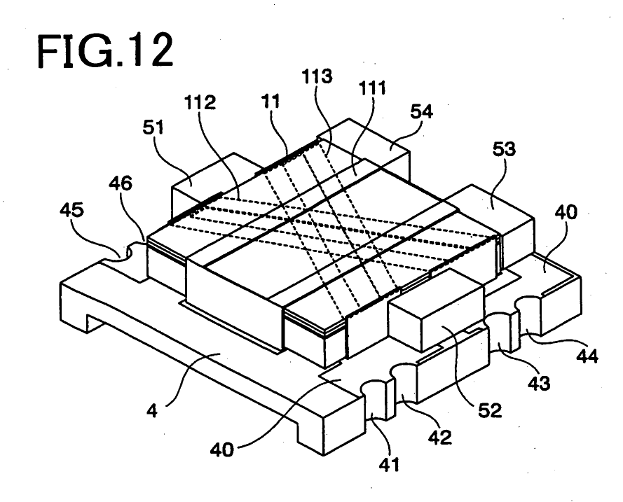

The embodiment illustrated in FIGS. 10 to 12 likewise shows an example of an isolator. In the drawings, like reference numerals denote parts corresponding to the constituent parts depicted in FIGS. 8 and 9, thereby eliminating the tautological explanation.

In the embodiment shown in FIGS. 10 to 12, a conductor pattern 40, which is used to connect capacitors 51 and 52, terminating resistors 53 and 53 and central conductors 111 and 113 with each other, is formed as a predetermined pattern on one surface of a support substrate 4. Further, concave grooves 41 to 46 or the like are provided on side surfaces of the support substrate 4, and a conductor film which is continuous with the conductor pattern 40 is given in each of the concave grooves 41 to 46. Of the concave grooves 41 to 46, for example, the concave grooves 41 and 42 are used as input terminals, the concave grooves 43 and 44 are used as ground terminals, and the concave grooves 45 and 46 are used as output terminals.

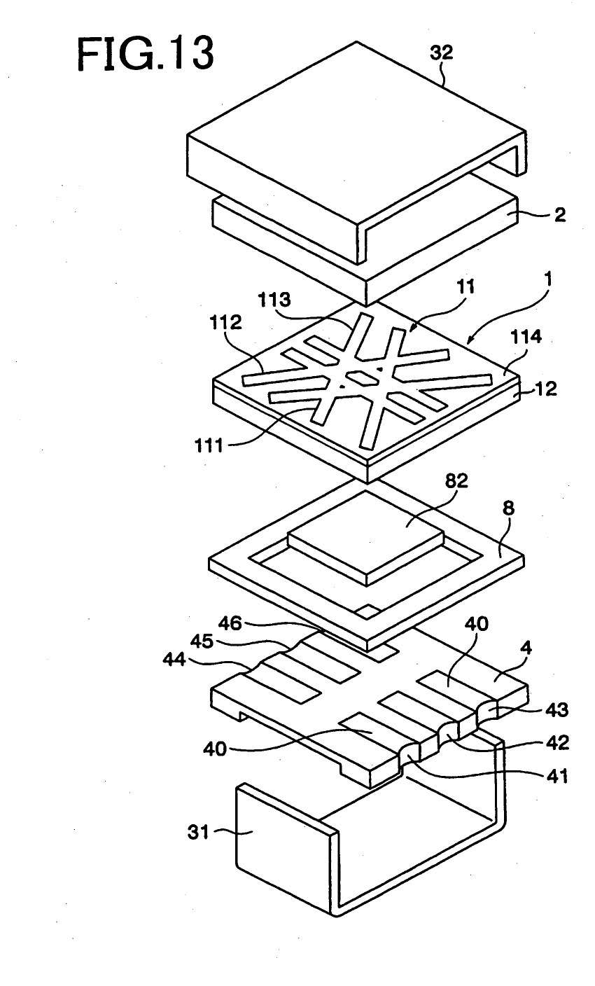

FIG. 13 is an exploded perspective view showing an embodiment of the non-reciprocal circuit device according to the present invention. In the drawing, like reference numerals denote parts corresponding to the constituent parts shown in FIGS. 8 to 12, thereby eliminating the tautological explanation. A gyromagnetic component 1 has a configuration in which an insulating film 114 is caused to adhere to one surface of a ferrite substrate 12 and a center electrode 11 is formed as a conductor film on this insulating film 14. Central conductors 111 to 113 constituting the center electrode 11 are insulated from each other and formed on the insulating film 114 caused to adhere to the upper surface of the ferrite substrate 12. When leading out the central conductors 111 to 113, a through hole technique or the like can be applied.

An outer shape of the gyromagnetic component 1 is substantially the same as that of a permanent magnet 2. Furthermore, a plane outer shape of the support substrate 4 is substantially the same as those of the gyromagnetic component 1 and the permanent magnet 2. When such a configuration is adopted, in a process of manufacturing an aggregate in which many non-reciprocal circuit devices are arranged in a lattice-like form and applying cutting processing to this aggregate to individually take out the non-reciprocal circuit devices, an aggregate for support substrates 4, an aggregate for the gyromagnetic components 1 and an aggregate for the permanent magnet 2 are superimposed and the entire structure is cut so that each assembly including the support substrate 4, the gyromagnetic component 1 and the permanent magnet 2 can be individually taken out.

The gyromagnetic component 1 is joined to the support substrate 4 through a functional substrate 82 including capacitors and a terminating resistor required in a circuit configuration. In this case, as described above, it is good enough to fill a space with an insulating resin 8. It is not necessary to fill the entire space, and filling exposed surfaces alone with the insulating resin 8 can suffice. Further, a bonding function may be provided to the above-described insulating resin 8. In this case, it is possible to improve securing strength between constituent components, e.g., the permanent magnet 2, the support substrate 4 and the gyromagnetic component 1.

In any of the foregoing embodiments, the gyromagnetic component 1 has a configuration in which at least a part of the ferrite substrate 12 is covered with the insulating film 114 and the center electrode 11 is caused to adhere to the surface of the insulating film 114, thereby obtaining the non-reciprocal circuit device having excellent high-frequency characteristics.

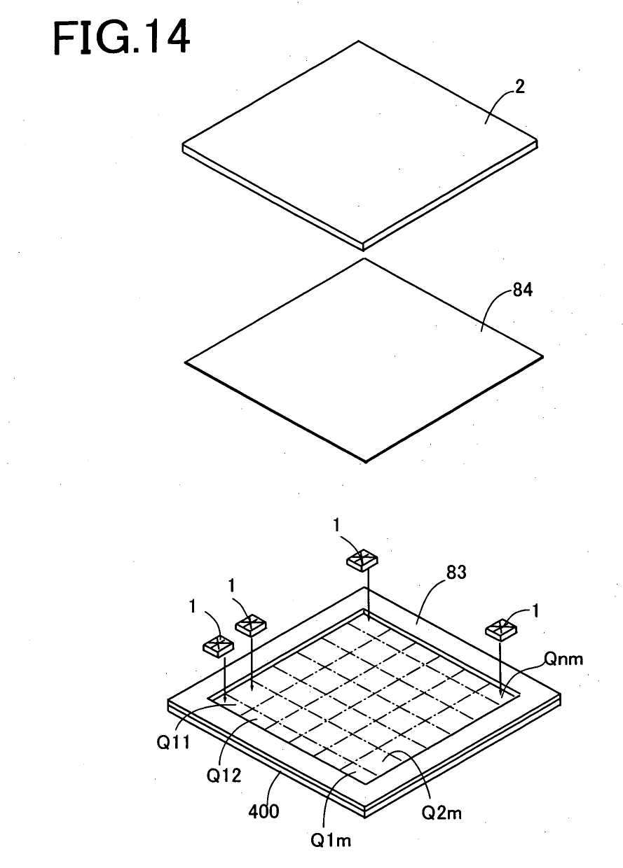

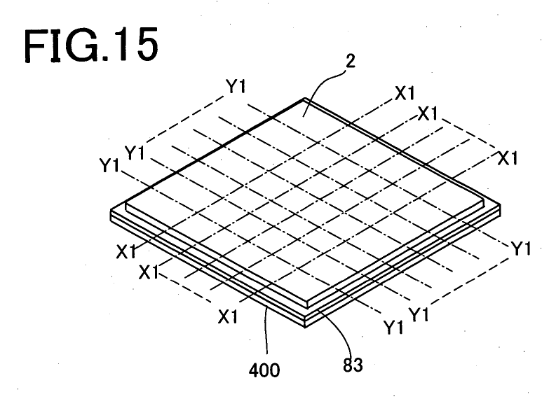

FIGS. 14 and 15 show a manufacturing method of the non-reciprocal circuit device using the gyromagnetic component according to the present invention. First, as shown in FIG. 14, a support substrate 400 in which many support portions Q11 to Qnm are arranged in a lattice-like form is manufactured, and a previously produced gyromagnetic component 1 according to the present invention is joined to each of the support portions Q11 to Qnm. Capacitors 51 and 52 and a terminating resistor 53 (54) (see FIG. 13) are attached together with the gyromagnetic component 1. It is good enough to provide a frame portion 83 on an outer rim of the support substrate 400 in order to prevent an injected resin from leaking.

Then, an insulating resin 8 is injected around the gyromagnetic component 1 on the support substrate 400, and a permanent magnet plate 200 is bonded by using an insulating adhesive layer 84. The permanent magnet plate 200 has a plane area which covers all the gyromagnetic components 1. When the insulating resin 8 is provided with an adhesion function, the permanent magnet 200 can be bonded without using the insulating adhesive layer 84. In a case where the insulating resin 8 is not used, an adhesive layer may be provided and bonded between contact surfaces of the gyromagnetic component 1 and the permanent 200, and the insulating resin 8 may be applied on exposed surfaces after cutting the entire structure to obtain each assembly.

Then, as shown in FIG. 15, the entire structure is cut along cutting lines X1-X1 and Y1-Y1 in accordance with each of the gyromagnetic components 1. As a result, each assembly including the support substrate 4, the gyromagnetic component 1 and the permanent magnet 2 can be obtained at a stroke. Thereafter, the non-reciprocal circuit device can be obtained by attaching a first yoke 31 and a second yoke 32.

In order to manufacture the non-reciprocal circuit device shown in FIG. 13, the aggregate in which the gyromagnetic components according to the present invention are arranged in a lattice-like form is superimposed and bonded on the support substrate 400, and the permanent magnet plate is superimposed and bonded thereon in FIG. 14. Thereafter, the cutting process shown in FIG. 15 is performed.

In a case where the insulating resin 8 is not used, an adhesive layer may be provided and bonded between contact surfaces of the functional substrate 82 and the gyromagnetic component aggregate 100, and the insulating resin 8 may be applied on exposed surfaces after cutting the entire structure to obtain each assembly.

As described above, in the non-reciprocal circuit device using the gyromagnetic component according to the present invention, it is possible to adopt the process of manufacturing the aggregate in which many non-reciprocal circuit devices are arranged in a lattice-like form to increase efficiency of the manufacturing process of the non-reciprocal circuit device and cutting this aggregate to take out each non-reciprocal circuit device, and hence mass production can be greatly improved, thereby providing the small and inexpensive reciprocal circuit device.

While the present invention has been particularly shown and described with reference to preferred embodiments thereof, it will be understood by those skilled in the art that various changes in form and detail may be made therein without departing from the spirit, scope and teaching of the invention.

What is claimed is:

1. A gyromagnetic component for a non-reciprocal circuit device, the gyromagnetic component comprising: a ferrite substrate; and a center electrode,
wherein at least a part of the ferrite substrate is covered with an insulating film, and
at least a part of the center electrode is caused to adhere to a surface of the insulating film.

2. A non-reciprocal circuit device comprising: a gyromagnetic component; a permanent magnet; and a yoke,
wherein the gyromagnetic component comprises an ferrite substrate and a center electrode,
at least a part of the ferrite substrate is covered with an insulating film, and
at least a part of the center electrode is caused to adhere to a surface of the insulating film,
the permanent magnet is provided on at least one surface side of the gyromagnetic component and applies a direct-current magnetic field to the gyromagnetic component, and
the yoke constitutes a magnetic path for a magnetic field generated by the permanent magnet.
